(19) United States
(12) Patent Application Publication
(10) Pub. No.: US 2008/0262803 A1
(43) Pub. Date: Oct. 23, 2008

(54) Method and Apparatus for Modeling Systems

(75) Inventors: Jose Carlos Merino Mombach, Santa Maria (BR); Eder Gusatto, Port Alegre (BR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/575,440

(22) PCT Filed: Sep. 15, 2005
(86) PCT No.: PCT/US2005/032968

§ 371 Date: Sep. 4, 2007

(30) Foreign Application Priority Data
Sep. 16, 2004 (GB) 0420600.9
Apr. 2, 2005 (GB) 0506743.4

(51) Int. Cl. G06F 17/10; G06G 7/48

(52) U.S. Cl. 703/2

(57) ABSTRACT

A method and apparatus is disclosed for processing a Potts model which uses random walk (RW) algorithms to improve the efficiency of the processing of the simulation data.

### FIELD OF INVENTION

The present invention relates to a method or apparatus for modeling systems using the Potts model.

### BACKGROUND OF THE INVENTION

In cellular patterns the surface energy between cells plays a central role in the evolution of the cellular structure. For example, in soap foams the minimization of the surface energy of the liquid films in the bubble walls make some cells grow and other shrink as disclosed by J A Glazier and D Weaire in The Kinetics of Cellular Patterns, Journal of Physics: Condensed Matter 4 (1992) 1867-1894. In the case of biological cells that are adherent, the minimization of the surface energy is an important mechanism of cellular pattern formation as discussed in the following references:
F M Maree and P Hogeweg, How amoeboids self-organize into a fruiting body: Multicellular co-ordination in Dictyostelium discoideum, Proceedings of the National Academy of Sciences of USA 98 (2001) 3879-3883.
J A Izaguirre, R Chatuverdi, C Huang et al, COMPUCELL, a multi-model framework for simulations of morphogenesis, Bioinformatics 20 (2004) 1129-1137.

E L Stott, N F Britton, J A Glazier, M Zajac, Stochastic simulation of benign avascular tumor growth using the Potts model, Mathematical and Computer Modeling 30 (1999) 183-198.

The Potts model noted in the above references was proposed to account for cellular processes. The Potts model is defined as follows: on a d-dimensional lattice, each site is attributed a label called spin that may assume any integer value. The set of all sites with equal spin S defines cell S. Adhesion between cells originates in the interaction between each spin and its surrounding neighbors. The lowest interaction energy is taken as zero and happens between equal spins simulating the absence of surface tension between sites belonging to the same cell. Energy between different cells is taken to be positive and when different biological types of cells are considered, the interaction energy may also be different depending on the types involved in the interaction. The interaction with an external medium can be also included.

The Potts model has Wide application in modeling complex systems. Applications include modeling foam coarsening, metallurgical grain growth, self organization of biological cells, micro organism development, magnetic material performance (particularly in computer memory and electronics applications often referred to as spintronics). However, the standard Monte Carlo algorithm used to evolve the Potts model is computationally expensive. As a result, modeling large complex systems requires large amounts of computer resources.

### SUMMARY OF THE INVENTION

Embodiments of the invention provide a method of updating a data set for use in a Potts model, the method comprising the steps of.

a) identifying a first boundary spin within the data set;
b) selectin g a second boundary spin at random from the neighboring spins of the first boundary spin;
c) identifying whether the first boundary spin should assume the second boundary spin value in accordance with a predetermined algorithm; and
d) updating the first boundary spin value in the data set in accordance with the algorithm.

The method may further comprise the step of selecting a third boundary spin at random from the neighboring spins of the second boundary spin and repeating steps c) and d) for the second and third boundary spins respectively. A random walk algorithm may be used for the selection of neighboring boundary spins. A Metropolis algorithm may be used in step c) to determine if a boundary spin should assume the value of a neighboring boundary spin. The Metropolis algorithm may be used with Boltzmann probability. In step a) the value of the first spin may be stored and in step d), prior to updating the data set, the stored value of the first spin may be compared to the value for the first spin held in the data set and if the values are different the results of the processing of step c) discarded. A data mutex may be used in step d) during the updating of the data set. Steps a) to d) may be performed a plurality of times in parallel on the data set. In step b) only neighboring spins from different cells may be selected.

Other embodiments of the invention provide apparatus arranged to update a data set for a Potts model, the apparatus comprising:

a selector module operable to select a first boundary spin within the data set held in a memory and to select a second boundary spin at random from the neighboring spins of the first boundary spin;
a processing module operable to identify whether the first boundary spin should assume the second boundary spin value in accordance with a predetermined algorithm; and
a data writing module operable to update the first boundary spin value in the data set in accordance with the algorithm.

Further embodiments of the invention provide apparatus arranged to update a data set for a Potts model, the apparatus comprising:

means for selecting a first boundary spin within the data set held in a memory;
means for selecting a second boundary spin at random from the neighboring spins of the first boundary spin;
means for identifying whether the first boundary spin should assume the second boundary spin value in accordance with a predetermined algorithm; and
means for updating the first boundary spin value in the data set in accordance with the algorithm.

Other embodiments of the invention provide a program or group of programs arranged to enable a computer or group of computers to carry out a method of updating a data set for use in a Potts model, the method comprising the steps of:

a) identifying a first boundary spin within the data set;
b) selecting a second boundary spin at random from the neighboring spins of the first boundary spin;
c) identifying whether the first boundary spin should assume the second boundary spin value in accordance with a predetermined algorithm; and
d) updating the first boundary spin value in the data set in accordance with the algorithm.

Further embodiments of the invention provide a program or group of programs arranged to enable a computer or group of computers to provide apparatus arranged to update a data set for a Potts model, the apparatus comprising:

a selector module operable to select a first boundary spin within the data set held in a memory and to select a second boundary spin at random from the neighboring spins of the first boundary spin;
a processing module operable to identify whether the first boundary spin should assume the second boundary spin value in accordance with a predetermined algorithm; and
a data writing module operable to update the first boundary spin value in the data set in accordance with the algorithm.

### BRIEF DESCRIPTION OF THE DRAWINGS

Embodiments of the invention will now be described, by way of example only, with reference to the accompanying drawings in which:

FIG. 1 is a schematic illustration of a Potts model;

FIG. 2 is a block diagram of an apparatus for processing the model of FIG. 1; and

FIG. 3 is a flow chart illustrating the processing carried out by the apparatus of FIG. 2.

### DETAILED DESCRIPTION OF PREFERRED EMBODIMENTS OF THE INVENTION

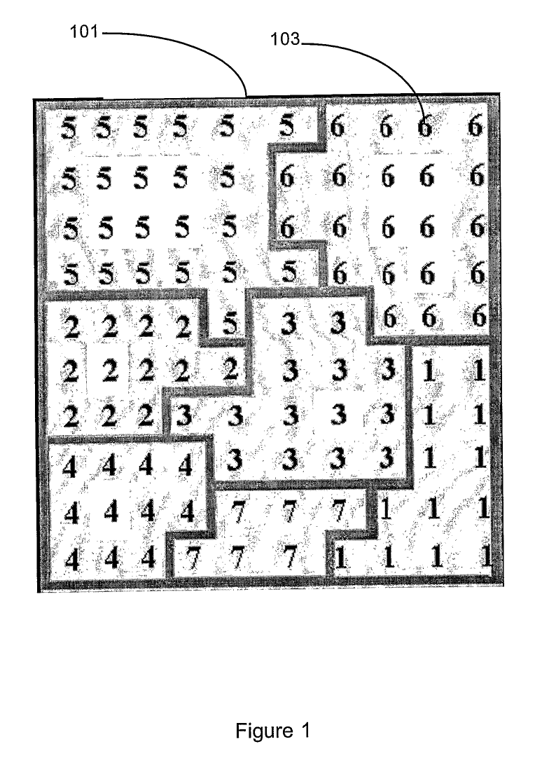

As noted above, the Potts model is defined as using a d-dimensional lattice and each site is attributed a label called spin that may assume any integer value. The set of all sites with equal spin S defines cell S. Adhesion between cells originates in the interaction between each spin and its surrounding neighbors. The lowest interaction energy is taken as zero and happens between equal spins simulating the absence of surface tension between sites belonging to the same cell. Energy between different cells is taken to be positive and when different types of cells are considered, the interaction energy may also be different, depending on the types involved in the interaction. The interaction with an external medium can be also included. FIG. 1 illustrates a small portion of a simulation lattice 101 with cells 103 represented by groups of equal numbers. To control cell compression, the Potts model includes an elastic energy term proportional to the square deviation of the cell volume from its target volume V_{T}(S). The complete energy used in the Monte Carlo protocol is:

$$E = {\sum }_{ijk} {\sum }_{{i}^{′} {j}^{′} k} {E}_{{S}_{ijk}} {S}_{{i}^{′} {j}^{′} k} ( 1 - {δ}_{{S}_{ijk} {S}_{{i}^{′} {j}^{′} k}} ) + λ {\sum }_{S} {[ v ( S ) - {V}_{T} ( S ) ]}^{2} \qquad Equation 1$$

where v(S) is the volume of cell S, Sᵢⱼₖ is the spin at site (i,j,k), and E_{SijkSi′j′l′} is the interaction energy between neighboring sites labeled by SijkSi′j′k′. If Sᵢⱼₖ₌Si′j′k′, then E_{SijkSi′j′k}=0 since in this case both sites belong to the same cell. Lambda is a cell compressibility parameter. In the two-dimensional simulation shown in FIG. 1, each spin has a higher range and interacts with the 20 spins surrounding it.

According to the Potts model, only spins on the boundaries of the cells (boundary spins) are candidates to change, since exchanges between equal spins do not change the configuration energy. Processing of a Potts model requires the location of boundary spins and then the calculation the probability of that spin assuming the value of a neighboring boundary spin. The probability P of exchanging or updating spins between neighbors is calculated according to the Metropolis algorithm with Boltzmann probability:

$$P ( S -> {S}^{′} ) = \{ \begin{matrix}exp ( - \frac{Δ E}{T} ) , & if Δ E > 0 , \\ 1 , & if Δ E \leq 0 ,\end{matrix} \qquad Equation 2$$

where ΔE is the variation in energy according to equation 1 above produced by the change of spin values. Consequently the algorithm evolves the Potts model minimizing the energy in equation 1.

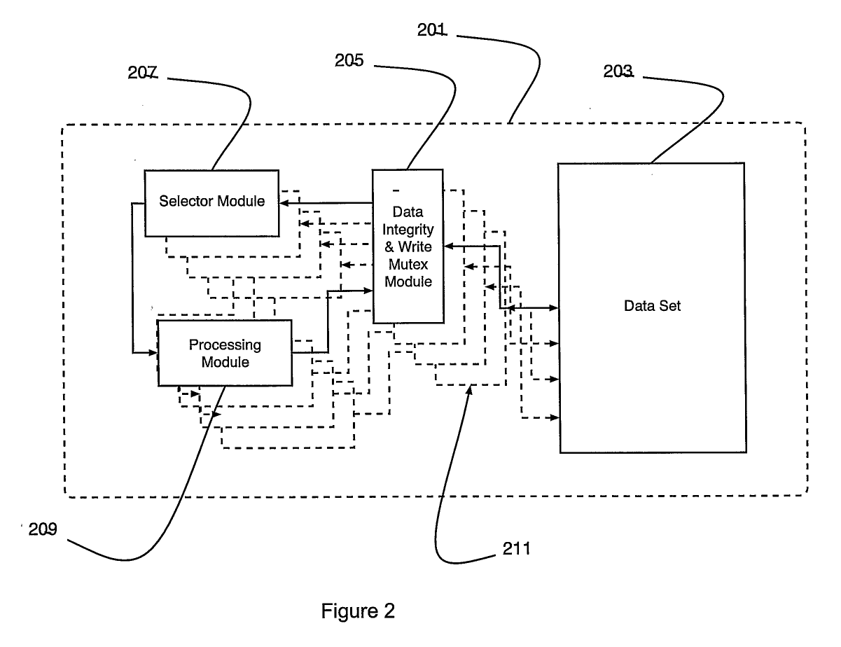

With reference to FIG. 2, a computer system in the form a personal computer (PC) with a four processor Intel™ Xeon™ with 1.5 GHz CPU's (not shown), which is loaded with a Potts modeling program 201. The program 201 creates a data structure 203 for storing a simulation lattice as shown in FIG. 1. The program comprises a set of modules 205, 207, 209 for processing the data in the data structure 203. The modules include a data integrity and write mutex (DIWM) module 205, a selector module 207 and a processing module 209. The processing of the simulation lattice held in the data structure 203 is performed in parallel on each of the four processors of the PC as indicated by the dotted outlines 211 in FIG. 2.

The DIWM module 205 provides synchronization mechanisms to avoid simultaneous accesses to shared data by the other two modules 207, 209 or parallel processes 211. When writing data, the DIWM module uses a mutex to ensure that the multiple processing threads serialize their accesses to the shared data 203 thus protecting the data from concurrent writes. A mutex structure offers lock and unlock operations, and is called just before a sequence of instructions to write to shared data are executed. A mutex unlock is called when a thread has finished the data write thereby freeing access to the data to other threads.

The DIWM module does however allow read operations to be achieved concurrently with any other read or write operations to avoid unnecessary mutex operations. This is allowed on the basis that the chance of simultaneous reads is low when the number of threads and the typical size of the data set is considered. Instead of a mutex an alternative mechanism is employed which guarantees that the shared data will be updated correctly. The data would be corrupted if when data is being read it is also updated. To deal with such simultaneous read and write operations the DIWM module is arranged to memorize each data element when it is initially read. Then, when writing that data after its processing by the other modules the DIWM module compares the initially read data element with the corresponding data that remained in the data structure. If the two data elements are equal then the data integrity has been maintained. If not, the data remaining in the data structure has been corrupted by a write by another processing thread during the time when the current thread was processing the data element. If the data is corrupted, the processing results are discarded and the process is restarted. Although this implementation discards some processor time, it improves the execution performance because, in practice, the number of discards is relatively small. The selector module 207 uses a random walk (RV) algorithm which is arranged to move only on cell boundaries in the simulation lattice. The RW algorithm initiates after finding any boundary spin as its starting position. From this position the RW algorithm moves to another randomly chosen boundary spin site neighboring the current site. The two spins selected are always boundary spins but may be from the same cell. When a new position is chosen, the data from the two sites is passed to the processing module 209 which performs an update of the spin at the current position in relation to the spin of the neighboring site according to the Metropolis algorithm described above in relation to equations 1 and 2. The processing module then updates the simulation lattice accordingly via the DIWM module 209. Where the two selected boundary spins are from the same cell then no change in their values will occur.

Once this first set of data has been located and passed to the processing module, the RW algorithm moves to the neighboring site, treating it as a new current site and selecting a new neighboring boundary spin site. This new data set is passed to the processing algorithm and the process repeats until the simulation is complete. The RW algorithm steps can be summarized as follows:
1. Find any boundary spin;
2. Choose randomly a neighboring boundary spin of the current site;
3. Calculate the probability P that current site spin assumes the spin of the neighboring site;
4. Move to neighboring site;
5. Check if current site is still boundary, if not go to 1; and
6. Go to 2.

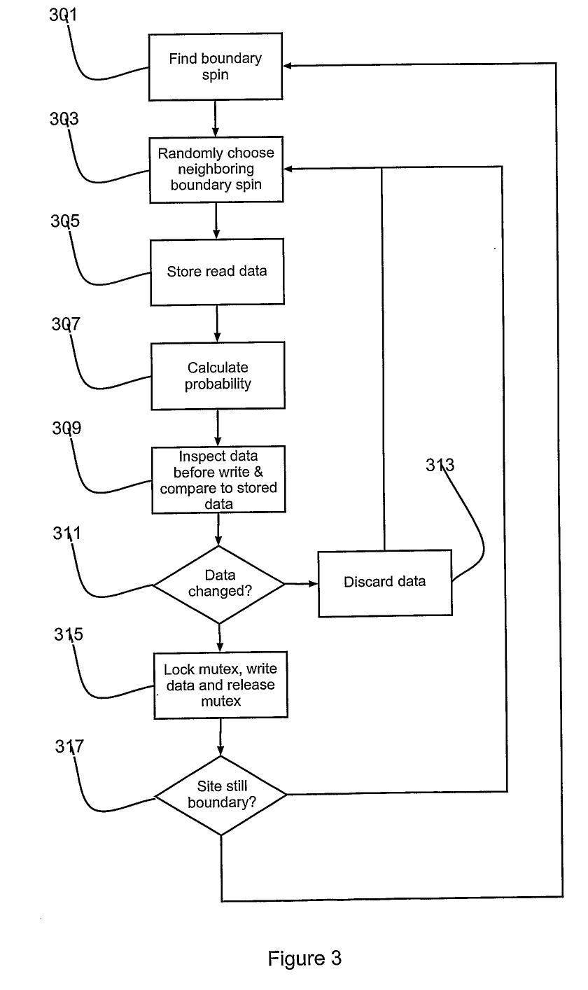

The processing carried out by the Potts modeling program 201 will now be described with reference to FIG. 3 in which at step 301, the process begins with the location of a first boundary spin by the selector module 207 by inspecting pairs of elements from the simulation lattice in the data structure 203. Once a boundary spin is found processing moves to step 303 where the RW algorithm in the selector module 207 randomly chooses a neighboring boundary spin. At step 305 the value of the current boundary spin selected in step 301 is stored by the DIWM module and processing moves to step 307.

At step 307, the processing module 209 takes the values of the current and neighboring boundary spins and uses equations 1 and 2 above to calculate whether or not the current boundary spin assumes the value of the neighboring boundary spin. At step 309 the current value for the current boundary spin in the data structure is compared by the DIWM module to the original value stored in step 305. At step 311, if the current and stored values for the current boundary value have changed, this indicates that the data has been corrupted and so processing moves to step 313 where the new data calculated in step 307 is discarded and processing returns to step 303 where a new neighbor is selected as described above.

If at step 311 the data has not changed then processing moves to step 315 where the write mutex locks the lattice location for the current boundary value, the new value is written to the location and the mutex releases the location. The first update of the boundary spins of the lattice is then complete. Processing continues to step 317 in the next iteration of the updating process and establishes whether or not, as a result of any updates to the surrounding lattice elements, that the neighboring boundary spin remains a boundary spin. If so, the neighboring boundary spin is treated as the current boundary spin and processing moves to step 303 where one of its neighboring boundary spins is selected as described above. If at step 317, the neighboring spin is no longer a boundary spin then processing moves to step 301 where the process restarts. The processing of the data in the simulation lattice is repeated for a predetermined number of iterations as required for the given model.

In another embodiment, the modeling program can be run on a single processor computer. In a further embodiment, the program is run on a single processor computer with a multi threading operating system with each iteration of the program running on a separate thread in parallel. In another embodiment the program has a non-modular program structure.

In other embodiments, the RW algorithm only selects neighboring spins which are from a different cell from the current spin. This is implemented by comparing the spins of neighbors to the current spin and choosing randomly from those with different spin values.

In tests the RW algorithm speeds up simulations of the Potts model, illustrating that, at least in the test scenarios, the algorithm is faster than the standard algorithm commonly used and faster still if used with multiprocessor or multithreading computer architectures. The algorithm can be applied to any version of the Potts model regardless of the application of that model.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via various transmission or storage means such as computer network, or any suitable storage medium so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method of updating a data set for use in a Potts model, the method comprising the steps of: a) identifying a first boundary spin within the data set; b) selecting a second boundary spin at random from the neighboring spins of said first boundary spin; c) identifying whether said first boundary spin should assume said second boundary spin value in accordance with a predetermined algorithm; and d) updating said first boundary spin value in said data set in accordance with said algorithm.

2. A method according to claim 1 further comprising the step of: e) selecting a third boundary spin at random from the neighboring spins of said second boundary spin and repeating steps c) and d) for said second and third boundary spins respectively.

3. A method according to claim 1 in which in a random walk algorithm is used for said selection of neighboring boundary spins.

4. A method according to claim 1 in which a Metropolis algorithm is used in step c) to determine if a boundary spin should assume the value of a neighboring boundary spin.

5. A method according to claim 4 in which the Metropolis algorithm is used with Boltzmann probability.

6. A method according to claim 1 in which in step a) the value of the first spin is stored and in step d), prior to updating said data set, the stored value of said first spin is compared to the value for said first spin held in said data set and if said values are different the results of the processing of step c) are discarded.

7. A method according to claim 1 in which a data mutex is used in step d) during the updating of said data set.

8. A method according to claim 1 in which steps a) to d) are performed a plurality of times in parallel on said data set.

9. A method according to claim 1 in which in step b) only neighboring spins from different cells are selected.

10. Apparatus arranged to update a data set for a Potts model, the apparatus comprising: a selector module operable to select a first boundary spin within the data set held in a memory and to select a second boundary spin at random from the neighboring spins of said first boundary spin; a processing module operable to identify whether said first boundary spin should assume said second boundary spin value in accordance with a predetermined algorithm; and a data writing module operable to update said first boundary spin value in said data set in accordance with said algorithm.

11. Apparatus according to claim 10 in which after the completion of the updating of the first boundary spin by said data writing module, said selector module is operable to select a third boundary spin at random from the neighboring spins of said second boundary spin for use by said processing module in identifying whether the second boundary spin should assume the third boundary spin value.

12. Apparatus according to claim 10 in which said selector module uses a random walk algorithm to select neighboring boundary spins.

13. Apparatus according to claim 10 in which said processing module uses a Metropolis algorithm to determine if a boundary spin should assume the value of a neighboring boundary spin.

14. Apparatus according to claim 13 in which the Metropolis algorithm is used with Boltzmann probability.

15. Apparatus according to claim 10 further comprising a data integrity module operable to store the value of a selected boundary spin and prior to the updating of said data set, to compare said stored value to the value to the value to be updated in said data set and if said values are different the updating is abandoned.

16. Apparatus according to claim 10 further comprising a data mutex module operable during the updating of said data set.

17. Apparatus according to claim 10 which is operable a plurality of times in parallel on said data set.

18. Apparatus according to claim 10 in which said selector module is operable to only neighboring spins from different cells are selected.

19. Apparatus arranged to update a data set for a Potts model, the apparatus comprising: means for selecting a first boundary spin within the data set held in a memory; means for selecting a second boundary spin at random from the neighboring spins of said first boundary spin; means for identifying whether said first boundary spin should assume said second boundary spin value in accordance with a predetermined algorithm; and means for updating said first boundary spin value in said data set in accordance with said algorithm.

20. A program or group of programs arranged to enable a computer or group of computers to carry out the method of claim 1.

21. A program or group of programs arranged to enable a computer or group of computers to provide the apparatus of claim 10.

22. A program or group of programs arranged to enable a computer or group of computers to provide the apparatus of claim 19.
